(19) United States
(12) Patent Application Publication
(10) Pub. No.: US 2026/0287284 A1
(43) Pub. Date: Sep. 24, 2026

(54) WIRELESS SHELL AND TUBE HEAT EXCHANGER FOULING PREDICTION SYSTEM

(71) Applicant: DOW GLOBAL TECHNOLOGIES LLC, Midland, MI (US)

(72) Inventor: Josue A. Ruiz, Rosharon, TX (US)

(73) Assignee: DOW GLOBAL TECHNOLOGIES LLC, Midland, MI (US)

(21) Appl. No.: 19/473,577

(22) PCT Filed: Apr. 11, 2024
(86) PCT No.: PCT/US2024/024023

§ 371 Date: Oct. 8, 2025

Related U.S. Application Data
(60) Provisional application No. 63/495,916, filed on Apr. 13, 2023.

(51) Int. Cl. F28F 27/00

(52) U.S. Cl. CPC F28F 27/00; F28F 2200/00

(57) ABSTRACT

A system may include a shell and tube heat exchanger with temperature sensors affixed to an outer surface of shell and tube inlet and outlet ports, flow rate sensors affixed to an outer surface of shell and tube inlet ports, and pressure sensors within Tees connected to the shell and tube inlet and outlet ports. Wireless transmitters may transmit sensor data from the sensors to a computing device. The computing device may determine one or more fouling indicators, based on the sensor data, indicating a likelihood of fouling occurring in the shell and tube heat exchanger.

### CROSS-REFERENCE TO RELATED APPLICATIONS

This application claims the benefit of U.S. Provisional Application Ser. No. 63/495,916 filed Apr. 13, 2023, the contents of which are incorporated in their entirety herein.

### TECHNICAL FIELD

The present specification relates to monitoring heat exchangers, and more particularly, to a wireless shell and tube heat exchanger fouling prediction system.

### BACKGROUND

A shell and tube heat exchanger comprises a shell with one or more tubes inside of the shell. One fluid flows through the tubes and another fluid flows through the shell over tube tubes. As such, heat may be exchanged between the two fluids. Shell and tube heat exchangers are used in a variety of manufacturing processes. In particular, they may remove heat from process fluids to maintain operating conditions within safe limits.

However, shell and tube heat exchangers are susceptible to fouling and superheating of cooling media. These effects can disrupt manufacturing processes that utilize shell and tube heat exchangers and lead to production losses. Early recognition of fouling and other harmful conditions may allow corrective action to be taken to minimize subsequent production losses. However, the installation of traditional instrumentation to continuously monitor operation of shell and tube heat exchangers can be expensive and time consuming and may lead to environmental health and safety concerns. As such, a need exists for an improved method of predicting fouling in shell and tube heat exchangers.

### SUMMARY

In one embodiment, a system may include a shell and tube heat exchanger, a plurality of sensors, a plurality of wireless transmitters, and a computing device. The shell and tube heat exchanger may include a shell inlet port, a shell outlet port, a tube inlet port, a tube outlet port, a first Tee connected to the shell inlet port, a second Tee connected to the shell outlet port, a third Tee connected to the tube inlet port, and a fourth Tee connected to the tube outlet port. A first temperature sensor may be affixed to an outer surface of the shell inlet port and may measure a first temperature of a fluid inside the shell inlet port. A second temperature sensor may be affixed to an outer surface of the shell outlet port and may measure a second temperature of the fluid inside the shell outlet port. A third temperature sensor may be affixed to an outer surface of the tube inlet port and may measure a third temperature of the fluid inside the tube inlet port. A fourth temperature sensor may be affixed to an outer surface of the tube outlet port and may measure a fourth temperature of the fluid inside the tube outlet port. A first flow rate sensor may be affixed to the outer surface of the shell inlet port and may measure a flow rate of the fluid inside the shell inlet port. A second flow rate sensor may be affixed to the outer surface of the shell outlet port and may measure a second flow rate of the fluid inside the shell outlet port. A first pressure sensor may be positioned inside the first Tee and may measure a first pressure of the fluid inside the shell inlet port. A second pressure sensor may be positioned inside the second Tee and may measure a second pressure of the fluid inside the shell outlet port. A third pressure sensor may be positioned inside the third Tee and may measure a third pressure of the fluid inside the tube inlet port. A fourth pressure sensor may be positioned inside the fourth Tee and may measure a fourth pressure of the fluid inside the tube outlet port. Each wireless transmitter may be connected to one of the sensors and may transmit data captured by a connected sensor to the computing device. The computing device may determine one or more fouling indicators based on the data received from the wireless transmitters. The one or more fouling indicators may indicate a likelihood of fouling occurring in the shell and tube heat exchanger.

In another embodiment, a method may include receiving first temperature data from a first wireless transmitter coupled to a first temperature sensor affixed to an outer surface of a shell inlet port of a shell and tube heat exchanger, receiving second temperature data from a second wireless transmitter coupled to a second temperature sensor affixed to an outer surface of a shell outlet port of the shell and tube heat exchanger, receiving third temperature data from a third wireless transmitter coupled to a third temperature sensor affixed to an outer surface of a tube inlet port of the shell and tube heat exchanger, receiving fourth temperature data from a fourth wireless transmitter coupled to a fourth temperature sensor affixed to an outer surface of a tube outlet port of the shell and tube heat exchanger, receiving first flow rate data from a fifth wireless transmitter coupled to a first flow rate sensor affixed to the outer surface of the shell inlet port of the shell and tube heat exchanger, receiving second flow rate data from a sixth wireless transmitter coupled to a second flow rate sensor affixed to the outer surface of the shell outlet port of the shell and tube heat exchanger, receiving first pressure data from a ninth wireless transmitter coupled to a first pressure sensor positioned inside of a first Tee connected to the shell inlet port of the shell and tube heat exchanger, receiving second pressure data from a tenth wireless transmitter coupled to a second pressure sensor positioned inside of a second Tee connected to the shell outlet port of the shell and tube heat exchanger, receiving third pressure data from an eleventh wireless transmitter coupled to a third pressure sensor positioned inside of a third Tee connected to the tube inlet port of the shell and tube heat exchanger, receiving fourth pressure data from a twelfth wireless transmitter coupled to a fourth pressure sensor positioned inside of a fourth Tee connected to the tube outlet port of the shell and tube heat exchanger, and determining one or more fouling indicators based on the first temperature data, the second temperature data, the third temperature data, the fourth temperature data, the first flow rate data, the second flow rate data, the first pressure data, the second pressure data, the third pressure data, and the fourth pressure data. The first temperature data may indicate a first temperature of a fluid inside the shell inlet port. The second temperature data may indicate a second temperature of the fluid inside the shell outlet port. The third temperature data may indicate a third temperature of the fluid inside the tube inlet port. The fourth temperature data may indicate a fourth temperature of the fluid inside the tube outlet port. The first flow rate data may indicate a first flow rate of the fluid inside the shell inlet port. The second flow rate data may indicate a second flow rate of the fluid inside the shell outlet port. The first pressure data may indicate a first pressure of the fluid inside the shell inlet port. The second pressure data may indicate a second pressure of the fluid inside the shell outlet port. The third pressure data may indicate a third pressure of the fluid inside the tube inlet port. The fourth pressure data may indicate a fourth pressure of the fluid inside the tube outlet port. The fouling indicators may indicate a likelihood of fouling occurring in the shell and tube heat exchanger.

In another embodiment, a method may include affixing a first temperature sensor to an outer surface of a shell inlet port of a shell and tube heat exchanger, affixing a second temperature sensor to an outer surface of a shell outlet port of the shell and tube heat exchanger, affixing a third temperature sensor to an outer surface of a tube inlet port of the shell and tube heat exchanger, affixing a fourth temperature sensor to an outer surface of a tube outlet port of the shell and tube heat exchanger, affixing a first flow rate sensor to the outer surface of the shell inlet port, affixing a second flow rate sensor to the outer surface of the shell outlet port, positioning a first pressure sensor inside a first Tee connected to the shell inlet port, positioning a second pressure sensor inside a second Tee connected to the shell outlet port, positioning a third pressure sensor inside a third Tee connected to the tube inlet port, positioning a fourth pressure sensor inside a fourth Tee connected to the tube outlet port, and connecting a corresponding wireless transmitter to each of the first temperature sensor, the second temperature sensor, the third temperature sensor, the fourth temperature sensor, the first flow rate sensor, the second flow rate sensor, the first pressure sensor, the second pressure sensor, the third pressure sensor, and the fourth pressure sensor. The first temperature sensor may measure a first temperature of a fluid inside the shell inlet port. The second temperature sensor may measure a second temperature of the fluid inside the shell outlet port. The third temperature sensor may measure a third temperature of the fluid inside the tube inlet port. The fourth temperature sensor may measure a fourth temperature of the fluid inside the tube outlet port. The first flow rate sensor may measure a flow rate of the fluid inside the shell inlet port. The second flow rate sensor may measure a second flow rate of the fluid inside the shell outlet port. The first pressure sensor may measure a first pressure of the fluid inside the shell inlet port. The second pressure sensor may measure a second pressure of the fluid inside the shell outlet port. The third pressure sensor may measure a third pressure of the fluid inside the tube inlet port. The fourth pressure sensor may measure a fourth pressure of the fluid inside the tube outlet port. Each wireless transmitter may transmit data captured by a connected sensor to a computing device

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts a wireless shell and tube heat exchanger fouling prediction system, according to one or more embodiments shown and described herein;

FIG. 2 schematically depicts a flow rate sensor, according to one or more embodiments shown and described herein;

FIG. 3 depicts a schematic diagram of the computing device of FIG. 1, according to one or more embodiments shown and described herein;

FIG. 4 schematically depicts a plurality of memory modules of the computing device of FIG. 3, according to one or more embodiments shown and described herein;

FIG. 5 schematically depicts a portion of another wireless shell and tube heat exchanger fouling prediction system, according to one or more embodiments shown and described herein;

FIG. 6 schematically depicts a portion of another wireless shell and tube heat exchanger fouling prediction system, according to one or more embodiments shown and described herein; and

FIG. 7 depicts a flowchart of an example method for operating the wireless shell and tube heat exchanger fouling prediction system of FIG. 1, according to one or more embodiments shown and described herein.

### DETAILED DESCRIPTION

The embodiments disclosed herein describe systems and methods for predicting fouling in a shell and tube heat exchanger. In particular, embodiments disclosed herein describe a wireless heat shell and tube heat exchanger fouling prediction system. In embodiments disclosed herein, a shell and tube heat exchanger may be referred to as a heat exchanger.

In embodiments disclosed herein, a system for monitoring performance of a heat exchanger comprises a plurality of clamp-on sensors that may be non-invasively installed onto an existing heat exchanger. In particular, the sensors may be clamped onto an external surface of a heat exchanger to measure data (e.g., performance indicators) associated with the heat exchanger. Because the sensors are clamped onto an external surface of a heat exchanger, they may be installed without interrupting continuous operation of the heat exchanger. The sensors may measure temperature, pressure, and fluid flow rate with the heat exchanger, as disclosed herein.

The system may also include a plurality of wireless transmitters that may connect to the sensors. In particular, each sensor may be connected to a wireless transmitter, which may wirelessly transmit the data gathered by the sensors to a remote computing device. As such, data may be collected from the sensors without the need for a wired connection to a computing device. The computing device may receive the sensor data and calculate heat exchanger fouling indicators or fouling coefficients based on the sensor data. The calculated heat exchanger fouling indicators may predict fouling in the heat exchanger. As such, when fouling is predicted, corrective action may be taken to prevent subsequent production losses.

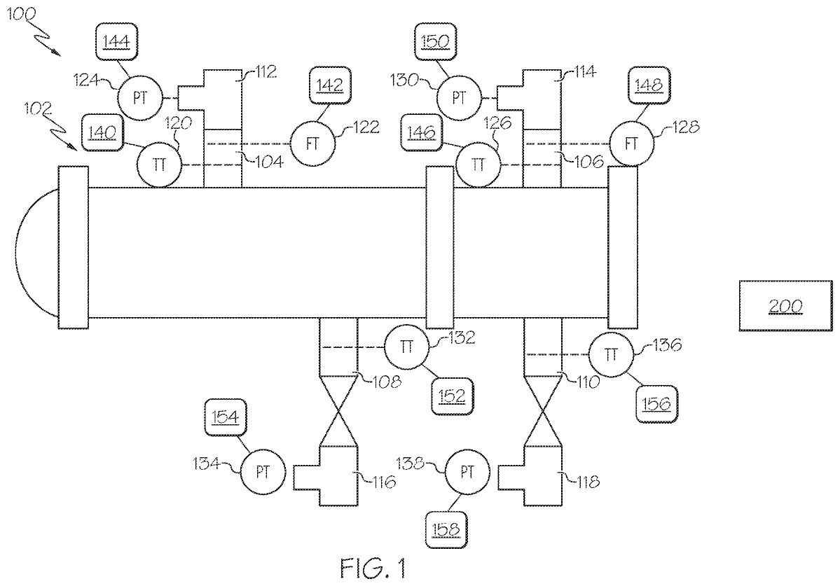

Turning now to the figures, FIG. 1 depicts an example heat exchanger fouling prediction system 100, according to embodiments disclosed herein. In the example of FIG. 1, the heat exchanger fouling prediction system 100 comprises a shell and tube heat exchanger 102 and a computing device 200. As used herein, the shell and tube heat exchanger 102 may be referred to as a heat exchanger.

A plurality of sensors may be clamped on or otherwise affixed to the heat exchanger 102, as disclosed herein. The sensors may collect data about the heat exchanger 102, as disclosed herein, and wirelessly transmit the data to the computing device 200. The sensors may be rated for hazard area classification, such that they can operate in the environment of the heat exchanger 102. In embodiments, the sensors may be rated for at least class 1, division 2, as defined by the National Electric Code. The computing device 200 may receive the data and may predict a state of the heat exchanger 102, such as whether the heat exchanger 102 is experiencing fouling or other conditions.

The heat exchanger 102 includes a shell and one or more tubes positioned inside of the shell. A first fluid may flow through the one or more tubes and a second fluid may flow over the tubes through the shell. If the first fluid and the second fluid have different temperatures, heat may be transferred from one fluid to the other. Accordingly, a cold first fluid may be placed into the shell in order to cool the second fluid flowing through the tubes.

In the example of FIG. 1, the heat exchanger 102 may comprise a shell inlet port 104, a tube inlet port 106, a shell outlet port 108, and a tube outlet port 110. The shell inlet port 104 may be used to deposit fluid into the shell and the tube inlet port 106 may be used to deposit fluid into the tube. The shell outlet port 108 may be used to drain fluid from the shell and the tube outlet port 110 may be used to drain fluid from the tube. A first Tee 112 may be connected to the shell inlet port 104. A second Tee 114 may be connected to the tube inlet port 106. A third Tee 116 may be connected to the shell outlet port 108. A fourth Tee 118 may be connected to the tube outlet port 110.

In the example of FIG. 1, a first temperature sensor 120 and a first flow rate sensor 122 may be affixed to an outer surface of the shell inlet port 104. A first pressure sensor 124 may be positioned inside the first Tee 112. A second temperature sensor 126 and a second flow rate 128 may be affixed to an outer surface of the tube inlet port 106. A second pressure sensor 130 may be positioned inside the second Tee 114. A third temperature sensor 132 may be affixed to an outer surface of the shell outlet port 108. A third pressure sensor 134 may be positioned inside the third Tee 116. A fourth temperature sensor 136 may be affixed to an outer surface of the tube outlet port 110. A fourth pressures sensor 138 may be positioned inside the fourth Tee 118.

In the illustrated example, the first, second, third, and fourth temperature sensors 120, 126, 132, 136 and the first and second flow rate sensors 122, 128 may be clamped onto the respective valves. However, in other examples, the temperature sensors and flow rate sensors may be affixed to an outer surface of the valves in any other manner. The first, second, third, and fourth pressure sensors 124, 130, 134, 138 may be positioned inside the respective Tees but not inserted into the streams of fluid flowing through the Tees.

The first, second, third, and fourth temperature sensors 120, 126, 132, 136 may directly measure a surface temperature of the shell inlet port 104, the tube inlet port 106, the shell outlet port 108, and the tube outlet port 110, respectively. Each temperature sensor may then determine an internal temperature of a fluid flowing through the respective valve based on the measured surface temperature and parameters of the valve including the thickness, diameter, and material of the pipe. As such, the temperature sensors 120, 126, 132, 136 may measure temperatures of the fluid inside the shell inlet port 104, the tube inlet port 106, the shell outlet port 108, and the tube outlet port 110, respectively.

The first and second flow rate sensors 122, 128 may measure a rate at which fluid flows through the shell inlet port 104 and the tube inlet port 106, respectively. In the illustrated example, the first and second flow rate sensors 122, 128 comprise ultrasonic sensors. However, in other examples, the first and second flow rate sensors 122, 128 may be constructed in other manners.

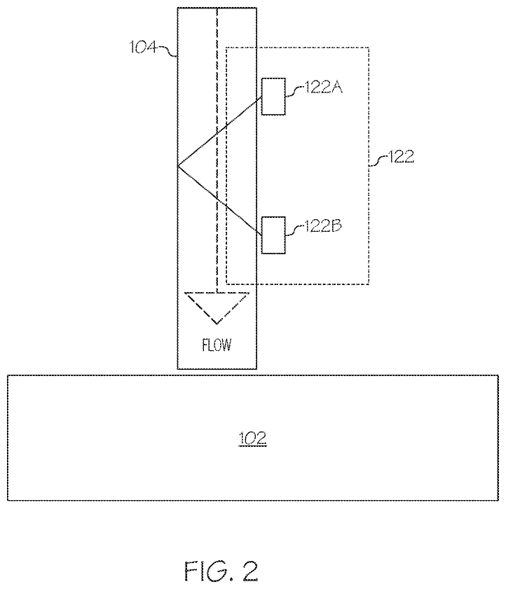

FIG. 2 shows an example first flow rate sensor 122. The second flow rate sensor 128 may be constructed in a similar manner. In the example of FIG. 2, the first flow rate sensor 122 comprises an upstream transducer 122A and a downstream transducer 122B. A fluid may flow through the shell inlet port 104 in a direction from the upstream transducer 122A to the downstream transducer 122B. In the example of FIG. 2, the upstream transducer 122A may emit an ultrasonic signal through the fluid in the shell inlet port 104 and the downstream transducer 122B may receive the ultrasonic signal. The time delay between when the ultrasonic signal is emitted by the upstream transducer 122A and received by the downstream transducer 122B may change based on the rate at which the fluid flows through the shell inlet port 104. As such, the first flow rate sensor 122 may measure the time delay between when the ultrasonic signal is emitted by the upstream transducer 122A and when the ultrasonic signal is received by the downstream transducer 122B, and may determine a rate of flow of the fluid through the shell inlet port 104 based on this time delay.

Referring back to FIG. 1, the first, second, third, and fourth pressure sensors 124, 130, 134, 138 may measure pressure within the first, second, third, and fourth Tees 112, 114, 116, 118, respectively. The measured values of temperature, flow rate, and pressure may be used to determine operational parameters of the heat exchanger 102, as discussed in further detail below.

Referring still to FIG. 1, the system 100 comprises a plurality of wireless transmitters to transmit data from the various sensors to the computing device 200. In particular, the system 100 comprises wireless transmitters 140, 146, 152, 156 connected to the first, second, third, and fourth temperature sensors 120, 126, 132, 136, respectively. The system 100 comprises wireless transmitters 142, 148 connected to the first and second flow rate sensors 122, 128, respectively. The system 100 comprises wireless transmitters 144, 150, 154, 158 connected to the first, second, third, and fourth pressure sensors 124, 130, 134, 138, respectively.

In embodiments, each of the wireless transmitters 140, 142, 144, 146, 148, 150, 152, 154, 156, 158 may receive data from the corresponding sensor to which they are connected, and may transmit the sensor data to the computing device 200. In some examples, the wireless transmitters may provide electrical power to the sensors that they are connected to.

By attaching sensors to external surfaces of the heat exchanger 102 and wireless transmitting sensor data to the computing device 200, the system 100 may allow for a determination of an operational state of the heat exchanger 102 without the need for internal sensors. As such, the sensors and wireless transmitters may be placed onto an existing shell and tube heat exchanger. Furthermore, by wirelessly transmitting the sensor data to the computing device 200, an operational state of the heat exchanger 102 can be determined while the situation is on-line from a remote location where the computing device 200 is located.

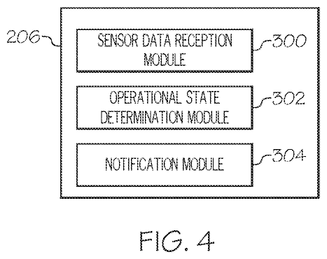

FIG. 4 schematically depicts an example configuration of the computing device 200 of FIG. 1. In some examples, the computing device 200 may be a remote computing device (e.g., a cloud computing device). However, in other examples, the computing device 200 may be located in the same location as the heat exchanger 102. In the illustrated example, the computing device 200 includes one or more processors 202, a communication path 204, one or more memory modules 206, a data storage component 208, and network interface hardware 210, the details of which will be set forth in the following paragraphs.

Each of the one or more processors 202 may be any device capable of executing machine readable and executable instructions. Accordingly, each of the one or more processors 202 may be a controller, an integrated circuit, a microchip, a computer, or any other physical or cloud-based computing device. The algorithms, including the trained models, signal preprocessing, and noise removal methods discussed below, may be executed by the one or more processors 202. The one or more processors 202 are coupled to a communication path 204 that provides signal interconnectivity between various modules of the computing device 200. Accordingly, the communication path 204 may communicatively couple any number of processors 202 with one another, and allow the modules coupled to the communication path 204 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 204 may be formed from any medium that is capable of transmitting a signal such as, for example, conductive wires, conductive traces, optical waveguides, or the like. In some embodiments, the communication path 204 may facilitate the transmission of wireless signals, such as WiFi, Bluetooth®, Near Field Communication (NFC) and the like. Moreover, the communication path 204 may be formed from a combination of mediums capable of transmitting signals. In one embodiment, the communication path 204 comprises a combination of conductive traces, conductive wires, connectors, and buses that cooperate to permit the transmission of electrical data signals to components such as processors, memories, sensors, input devices, output devices, and communication devices. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The computing device 200 includes one or more memory modules 206 coupled to the communication path 204. The one or more memory modules 206 may comprise RAM, ROM, flash memories, hard drives, or any device capable of storing machine readable and executable instructions such that the machine readable and executable instructions can be accessed by the one or more processors 202. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 206. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The memory modules 206 are discussed in more detail below in connection with FIG. 4.

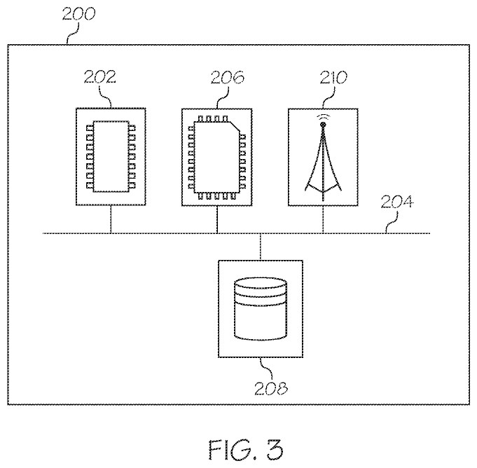

Referring still to FIG. 3, the example computing device 200 includes a data storage component 208. The data storage component 208 may store data received from the wireless transmitters connected to the various sensors of FIG. 1. The data storage component 208 may also store other data used by the various components of the computing device 200.

Still referring to FIG. 3, the computing device 200 comprises network interface hardware 210 for communicatively coupling the computing device 200 to the wireless transmitters of FIG. 1. As such, the network interface hardware 210 may receive sensor data from the wireless transmitters connected to the various sensors of FIG. 1. The network interface hardware 210 can be communicatively coupled to the communication path 204 and can be any device capable of transmitting and/or receiving data via a network. Accordingly, the network interface hardware 210 can include a communication transceiver for sending and/or receiving communication from the wireless transmitters of FIG. 1. For example, the network interface hardware 210 may include an antenna, a modem, LAN port, Wi-Fi card, WiMax card, mobile communications hardware, near-field communication hardware, satellite communication hardware and/or any wired or wireless hardware for communicating with the wireless transmitters of FIG. 1. In some examples, the network interface hardware 210 may also transmit signals to the wireless transmitters of FIG. 1.

Referring now to FIG. 4, the one or more memory modules 206 include a sensor data reception module 300 and an operational state determination module 302. Each of the sensor data reception module 300 and the operational state determination module 302 may be a program module in the form of operating systems, application program modules, and other program modules stored in one or more memory modules 206. Such a program module may include, but is not limited to, routines, subroutines, programs, objects, components, data structures and the like for performing specific tasks or executing specific data types as will be described below.

The sensor data reception module 300 may receive sensor data from the wireless transmitters 140, 142, 144, 146, 148, 150, 152, 154, 156, 158 of FIG. 1. In particular, the sensor data reception module 300 may receive temperature, flow rate, and/or pressure data from the respective temperature sensors, flow rate sensors, and pressure sensors connected to the wireless transmitters as discussed above. The sensor data received by the sensor data reception module 300 may be stored in the data storage component 208 and may be used by the operational state determination module 302 to determine an operational state of the heat exchanger 102, as explained in further detail below.

Referring back to FIG. 4, the operational state determination module 302 may determine a state of the heat exchanger 102 based on the sensor data received by the sensor data reception module 300, as disclosed herein. In the illustrated example, the operational state determination module 302 may determine fouling indicators including a heat transfer rate, an effectiveness, a C-Factor associated with the shell and a C-Factor associated with the tube, as disclosed herein. However, in other examples, the operational state determination module 302 may determine other indicators of the operational state of the heat exchanger 102.

A heat transfer rate may indicate a rate at which heat is transferred between the first fluid in the tubes of the heat exchanger 102 and a second fluid in the shell of the heat exchanger 102. The heat transfer rate may be one indication of an operational state of the heat exchanger 102. In embodiments, the operational state determination module 302 may determine the heat transfer rate Q using the following equation (1):

$$Q = U \times A \times LMTD \times F \qquad ( 1 )$$

where U is a heat transfer coefficient, A is an area to which heat is transferring, LMTD is a logarithmic mean temperature difference, and F is a correction factor.

In equation (1), U is the heat transfer coefficient associated with the materials of the heat exchanger 102. This may be a constant value associated with the manufacture of the heat exchanger 102.

In equation (1), A is the area to which heat is transferring between the first fluid in the tubes and the second fluid in the shell of the heat exchanger 102. In the illustrated example, A is the surface area of the shell in the heat exchanger 102.

In equation (1), LMTD is a logarithmic mean temperature difference between the first fluid in the tubes and the second fluid in the shell of the heat exchanger 102, and may be calculated using the following equation (2):

$$L M T D = \frac{{θ}_{1} - {θ}_{2}}{ln ( \frac{{θ}_{2}}{{θ}_{1}} )} \qquad ( 2 )$$

where:
θ₁=T₁−t₂; θ₂=T₂−t₁; T₁ is the temperature of the first fluid in the shell inlet port 104 measured by the first temperature sensor 120; T₂ is the temperature of the first fluid in the shell outlet port 108 measured by the third temperature sensor 132; t₁ is the temperature of the second fluid in the tube inlet port 106 measured by the second temperature sensor 126; and t₂ is the temperature of the second fluid in the tube outlet port 110 measured by the fourth temperature sensor 136.

In equation (1), the correction factor F may be calculated differently depending on whether the system 100 uses a single shell with 2 tube passes, or 2 shells with 4 tube passes. In one example, the system 100 may use a single shell with 2 tube passes. That is, the system 100 may comprise a single shell, as in the heat exchanger 102 of FIG. 1, and a tube within the shell may make 2 passes through the shell. That is, as a fluid enters the tube through the tube inlet port 106, the fluid may flow from a first end of the shell to a second end of the shell, and may then flow from the second end of the shell back to the first end of the shell before exiting through the tube outlet port 110. In this example of a single shell with 2 tube passes, a correction factor F₁₋₂ may be calculated using the following equation (3):

$${F}_{1 - 2} = \frac{\sqrt{{R}_{2} + 1}}{( R - 1 )} \times \frac{ln ( \frac{1 - P}{1 - P \times R} )}{ln ( \frac{\frac{2}{P} - 1 - R + \sqrt{{R}^{2} + 1}}{\frac{2}{P} - 1 - R - \sqrt{{R}^{2} + 1}} )} \qquad ( 3 )$$

$$where :$$

$$R = \frac{{T}_{1} - {T}_{2}}{{t}_{2} - {t}_{1}} ; and$$

$$P = \frac{{t}_{2} - {t}_{1}}{{T}_{2} - {t}_{1}} .$$

In another example, the system 100 may use two shells with 4 tube passes. That is, the system 100 may comprise a first shell, as in the heat exchanger 102 of FIG. 1, above a second shell, which may be constructed in the same manner as the heat exchanger 102. Within each shell, a fluid may make 2 passes through a tube, and as the fluid exits the first shell, it may enter the second shell and make an additional 2 passes through a tube. In this example of two shells with 4 passes, a correction factor F₂₋₄ may be calculated using the following equation (4):

$${F}_{2 - 4} = \frac{\sqrt{{R}^{2} + 1}}{2 \times ( R - 1 )} \times \frac{ln ( \frac{1 - P}{1 - P \times R} )}{ln ( \frac{\frac{2}{P} - 1 - R + \frac{2}{P} \sqrt{( 1 - P ) ( 1 - P \times R )} + \sqrt{{R}_{2} + 1}}{\frac{2}{P} - 1 - R + \frac{2}{P} \sqrt{( 1 - P ) ( 1 - P \times R )} - \sqrt{{R}^{2} + 1}} )} \qquad ( 4 )$$

In embodiments, the operational state determination module 302 may determine either F₁₋₂ or F₂₋₄ using the above equations depending on the type of system 100 being used. Then, the operational state determination module 302 may determine the correction factor F in equation (1) by multiplying either F₁₋₂ or F₂₋₄ by a manufacturer correction factor associated with the geometry of the heat exchanger 102. The manufacturer correction factor may be provided by the manufacturer of the heat exchanger 102.

Thus, in embodiments, the temperature sensors 120, 126, 132, 136 may continually measure the temperature in the shell inlet and outlet ports and the tube inlet and outlet ports of the heat exchanger 102, and the wireless transmitters 140, 146, 152, 156 may transmit the measured temperatures to the computing device 200. The sensor data reception module 300 may receive the measured temperature values, and the operational state determination module 302 may use the received temperature values to determine the heat transfer rate using the above equations. In particular, the operational state determination module 302 may monitor the heat transfer rate over time to determine the operational state of the heat exchanger 102. In particular, as fouling or other conditions occur in the heat exchanger 102, the heat transfer rate may reduce. As such, the calculated heat transfer rate may indicate fouling or other conditions, as explained in further detail below.

In addition to determining the heat transfer rate, the operational state determination module 302 may also determine an effectiveness, which may indicate a ratio of the actual heat transfer to the maximum possible heat transfer. In embodiments, the operational state determination module 302 may determine an effectiveness S, using the below equation (5):

$$S = \frac{{t}_{2} - {t}_{1}}{{T}_{1} - {T}_{2}} \qquad ( 5 )$$

In embodiments, the operational state determination module 302 may determine the effectiveness value based on the temperature measurements received by the sensor data reception module 300. As fouling or other conditions occur in the heat exchanger 102, the effectiveness may be reduced. As such, the calculated effectiveness may indicate fouling or other conditions in the heat exchanger 102.

The operational state determination module 302 may also determine a first C-Factor associated with the shell of the heat exchanger 102, and a second C-Factor associated with the tube of the heat exchanger 102. The C-Factor correlates flow rate with pressure drop due to fouling, and may be calculated using the below equation (6):

$$C - Factor = \frac{\sqrt{Δ P}}{V} \qquad ( 6 )$$

where ΔP is a difference in pressure between an inlet port and an outlet port, and V is a fluid velocity.

The operational state determination module 302 may calculate the first C-Factor associated with the shell of the heat exchanger 102 by determining a difference between the pressure in the first Tee 112 measured by the first pressure sensor 124 and the pressure in the third Tee 116 measured by the third pressure sensor 134, and by determining a flow rate in the shell inlet port 104 measured by the first flow rate sensor 122. The operational state determination module 302 may calculate the second C-Factor associated with the tube of the heat exchanger 102 by determining a difference between the pressure in the second Tee 114 measured by the second pressure sensor 130 and the pressure in the fourth Tee 118 measured by the fourth pressure sensor 138, and by determining a flow rate in the tube inlet port 106 measured by the second flow rate sensor 128.

Thus, in embodiments, the pressure sensors 124, 130, 134, 138 and the flow rate sensors 122, 128 may continually measure pressure and flow rate values, and the wireless transmitters 144, 150, 154, 158, 142, 148 may transmit the measured pressure and flow rate values to the computing device 200. The operational state determination module 302 may receive the measured pressure and flow rate values and the operational state determination module 302 may determine the first and second C-Factors for the shell and tube, respectively, of the heat exchanger 102 using the received values and the equations above. The C-Factors may give an indication as to whether fouling is occurring in the heat exchanger 102.

Referring still to FIG. 4, the notification module 304 may monitor the indicators determined by the operational state determination module 302 (e.g., heat transfer rate, effectiveness, and C-Factor), and may output a notification based on the values of those indicators, as disclosed herein. In embodiments, a user may specify one or more thresholds associated with the different indicators determined by the operational state determination module 302. For example, a user may specify minimum values for the heat transfer rate, effectiveness, and/or C-Factor determined by the operational state determination module 302. The notification module 304 may then monitor the values of these indicators and determine whether any of their values fall below the corresponding threshold. In other examples, a user may specify a maximum allowable change in one or more of the heat transfer rate, effectiveness, and/or C-Factor. In these examples, the notification module 304 may monitor the values of the indicators and determine whether any of their values have dropped by more than the maximum allowable amount. In some examples, one or more of these thresholds may be predetermined rather than specified by a user.

If the notification module 304 determines that one or more of the indicators determined by the operational state determination module 302 has fallen below a threshold. Upon determination that one or more of the values of the indicators has fallen below a threshold, the notification module 304 may transmit and/or output a notification indicating as much. The notification module 304 may transmit and/or output such a notification in a variety of ways. For example, the notification module 304 may cause the computing device 200 to output a warning, or the notification module 304 may transmit a notification to a user's smartphone or other device. In some examples, the notification may indicate the specific indicator or indicators that have fallen below a threshold and/or the specific value of the indicator.

The notification transmitted and/or output by the notification module 304 may indicate to a user that fouling has likely occurred or is expected to occur in the heat exchanger 102. As such, when a notification is received, the user may cause maintenance to be performed on the heat exchanger 102 to correct any issues that may be causing following, thereby allowing the heat exchanger 102 to continue operating in an efficient manner.

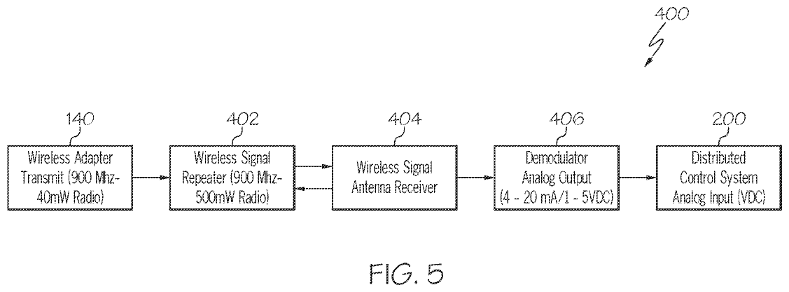

Turning now to FIG. 5, a portion of an example heat exchanger fouling prediction system 400 is shown. In the example of FIG. 5, the system 400 may include the heat exchanger 102 and the computing device 200. In addition, the system 400 may include a wireless signal repeater 402, a wireless signal antenna receiver 404, and a demodulator 406. In the example of FIG. 5, the computing device 200 is a local computer that may be located in the same facility as the heat exchanger 102.

In the example of FIG. 5, the wireless transmitter 140 transmits sensor data at a frequency of 900 MHz via a 40 mW radio signal. However, it should be understood that in other examples, the wireless transmitter 140 may transmit sensor data at a different frequency and/or protocol. In some examples, the wireless transmitter 140 may transmit sensor data at multiple frequencies (e.g., 900 MHz and 2.6 GHZ) to increase redundancy of transmission. In the example of FIG. 5, only the wireless transmitter 140 is shown. However, the wireless transmitters 142, 144, 146, 148, 150, 152, 154, 156, 158 may transmit data in a similar manner.

In the example of FIG. 5, the wireless signal repeater 402 may receive the sensor data transmitted by the wireless transmitter 140. The wireless signal repeater 402 may then re-transmit the received sensor data, thereby increasing the range at which the sensor data may be transmitted. In the example of FIG. 5, the wireless signal repeater 402 transmits the sensor data at a frequency of 900 MHz via a 500 mW radio signal. However, in other examples, the wireless signal repeater 402 may transmit the received sensor data at a different frequency and/or protocol.

The wireless signal antenna receiver 404 may receive the sensor data transmitted by the wireless signal repeater 402. Because the wireless signal repeater 402 re-transmits the sensor data transmitted by the wireless transmitter 140, the wireless signal antenna receiver 404 may be positioned at a distance further away from the wireless transmitter 140 than would be possible if the wireless signal antenna receiver 404 were receiving the signal directly from the wireless transmitter 140. In some examples, the wireless signal antenna receiver 404 may send a signal to the wireless signal repeater 402 if the sensor data is not properly received. This may cause the wireless signal repeater 402 to re-transmit the data, thereby increasing the resiliency of the data flow pipeline. The sensor data received by the wireless signal antenna receiver 404 may be input to the demodulator 406.

The demodulator 406 may demodulate the signal received by the wireless signal antenna receiver 404. The demodulator 406 may then output the demodulated signal to the computing device 200. In the illustrated example, the demodulator 406 operates with a current of 4-20 mA and a DC voltage of 1-5V. However, in other examples, the demodulator 406 may operate with any other voltage and current. The computing device 200 may receive the demodulated sensor data via a distributed control system analog input.

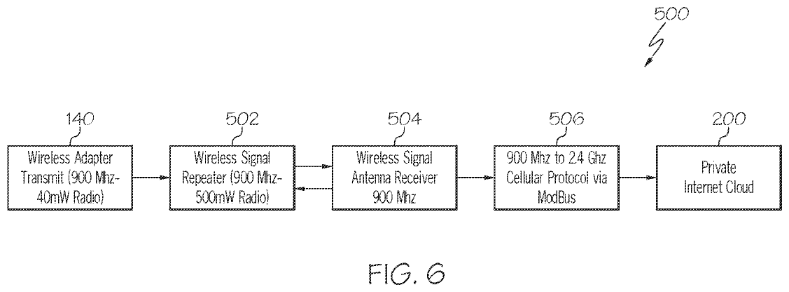

FIG. 6 shows a portion of an example heat exchanger fouling prediction system 500. The example system 500 of FIG. 6 is similar to the example system 400 of FIG. 4, and includes the heat exchanger 102, a wireless signal repeater 502, a wireless signal antenna receiver 504, and a cellular transmitter 506. In the example of FIG. 6, the computing device 200 is a cloud computing device.

In the example of FIG. 6, the wireless signal repeater 502 may be constructed in a similar manner as the wireless signal repeater 402 of FIG. 5. The wireless signal antenna receiver 504 may be constructed in a similar manner as the wireless signal antenna receiver 404 of FIG. 5.

In the example of FIG. 6, the cellular transmitter 506 may convert the sensor data received by the wireless signal antenna receiver 504 to a cellular signal, which may be transmitted to the cloud computing device 200. In the example of FIG. 6, the cellular transmitter converts a 900 MHz signal to a 2.4 GHz signal and transmits the data using the ModBus protocol. However, in other examples, the cellular transmitter may utilize other frequencies and/or transmission protocols.

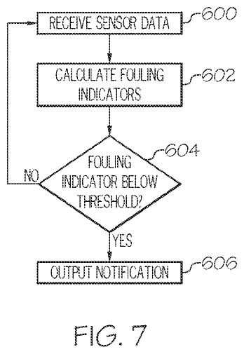

FIG. 7 depicts a flowchart of an example method for operating the computing device 200 to predict fouling in the heat exchanger 102. At step 600, the sensor data reception module 300 receives sensor data from the wireless transmitters 140, 142, 144, 146, 148, 150, 152, 154, 156, 158 indicating temperature, pressure, and flow rate values measured by the sensors 120, 122, 124, 126, 128, 130, 132, 134, 136, 138.

At step 602, the operational state determination module 302 calculates one or more fouling indicators. In particular, the operational state determination module 302 may determine a heat transfer rate of the heat exchanger 102, an effectiveness of the heat exchanger 102, a C-Factor of the shell of the heat exchanger 102, and a C-Factor of the tube of the heat exchanger 102. The operational state determination module 302 may determine the fouling indicators using the equations described above.

At step 604, the notification module 304 determines whether one or more values of the fouling indicators calculated by the operational state determination module 302 is below an associated threshold. If the notification module 304 determines that none of the values of the fouling indicators are below an associated threshold (NO at step 604), control returns to step 600 and the sensor data reception module 300 receives additional sensor data. If the notification module 304 determines that one or more of the values of the fouling indicators are below an associated threshold (YES at step 604), then at step 606, the notification module 304 outputs a warning or notification to a user.

It should now be understood that embodiments described herein are directed to a wireless shell and tube heat exchanger fouling prediction system. In particular, temperature sensors, flow rate sensors, and pressure sensors may be clamped onto a shell and tube heat exchanger as described herein. Wireless transmitters may be connected to the various sensors, which may wirelessly transmit sensor data recorded by the various sensors to a computing device. The computing device may determine fouling indicators based on the received sensor data. Fouling may be predicted based on the fouling indicators determined by the computing device, thereby allowing preventive maintenance to occur. This may allow problems with the heat exchanger to be corrected before they become detrimental to its operation, thereby maintaining efficient operation of the heat exchanger. Furthermore, by utilizing clamp-on sensors and wireless transmitters, the fouling prediction system may be retrofitted to existing shell and tube heat exchangers, and fouling may be monitored remotely.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A system comprising:
a shell and tube heat exchanger comprising a shell inlet port, a shell outlet port, a tube inlet port, a tube outlet port, a first Tee connected to the shell inlet port, a second Tee connected to the shell outlet port, a third Tee connected to the tube inlet port, and a fourth Tee connected to the tube outlet port;
a computing device;
a first temperature sensor affixed to an outer surface of the shell inlet port and configured to measure a first temperature of a fluid inside the shell inlet port;
a second temperature sensor affixed to an outer surface of the shell outlet port and configured to measure a second temperature of the fluid inside the shell outlet port;
a third temperature sensor affixed to an outer surface of the tube inlet port and configured to measure a third temperature of the fluid inside the tube inlet port;
a fourth temperature sensor affixed to an outer surface of the tube outlet port and configured to measure a fourth temperature of the fluid inside the tube outlet port;
a first flow rate sensor affixed to the outer surface of the shell inlet port and configured to measure a flow rate of the fluid inside the shell inlet port;
a second flow rate sensor affixed to the outer surface of the shell outlet port and configured to measure a second flow rate of the fluid inside the shell outlet port;
a first pressure sensor positioned inside the first Tee and configured to measure a first pressure of the fluid inside the shell inlet port;
a second pressure sensor positioned inside the second Tee and configured to measure a second pressure of the fluid inside the shell outlet port;
a third pressure sensor positioned inside the third Tee and configured to measure a third pressure of the fluid inside the tube inlet port;
a fourth pressure sensor positioned inside the fourth Tee and configured to measure a fourth pressure of the fluid inside the tube outlet port; and
a plurality of wireless transmitters, wherein each wireless transmitter of the plurality of wireless transmitters is connected to one of the first temperature sensor, the second temperature sensor, the third temperature sensor, the fourth temperature sensor, the first flow rate sensor, the second flow rate sensor, the first pressure sensor, the second pressure sensor, the third pressure sensor, and the fourth pressure sensor, and wherein each wireless transmitter of the plurality of wireless transmitters is configured to transmit data captured by a connected sensor to the computing device;
wherein the computing device is configured to determine one or more fouling indicators based on the data received from the plurality of wireless transmitters, the one or more fouling indicators indicating a likelihood of fouling occurring in the shell and tube heat exchanger.

2. The system of claim 1, wherein the first temperature sensor is configured to measure a surface temperature of the outer surface of shell inlet port and determine the first temperature of the fluid inside the shell inlet port based at least in part on the surface temperature.

3. The system of claim 1, wherein the first flow rate sensor comprises an ultrasonic sensor.

4. The system of claim 1, wherein the first temperature sensor is clamped onto the outer surface of the shell inlet port.

5. The system of claim 1, wherein the computing device comprises a cloud computing device.

6. The system of claim 1, wherein the first temperature sensor, the first flow rate sensor, and the first pressure sensor are rated for hazardous area classification.

7. The system of claim 1, wherein the computing device is configured to:
determine whether one or more of the fouling indicators are below one or more predetermined thresholds; and
upon determination that one or more of the fouling indicators are below the one or more predetermined thresholds, output a notification to a user.

8. The system of claim 1, further comprising a signal repeater configured to receive the data transmitted by the plurality of wireless transmitters and re-transmit the received data to the computing device.

9. The system of claim 8, further comprising an antenna configured to receive the data re-transmitted by the signal repeater, convert the data to cellular data, and transmit the cellular data to the computing device.

10. A method comprising:
receiving first temperature data from a first wireless transmitter coupled to a first temperature sensor affixed to an outer surface of a shell inlet port of a shell and tube heat exchanger, the first temperature data indicating a first temperature of a fluid inside the shell inlet port;
receiving second temperature data from a second wireless transmitter coupled to a second temperature sensor affixed to an outer surface of a shell outlet port of the shell and tube heat exchanger, the second temperature data indicating a second temperature of the fluid inside the shell outlet port;
receiving third temperature data from a third wireless transmitter coupled to a third temperature sensor affixed to an outer surface of a tube inlet port of the shell and tube heat exchanger, the third temperature data indicating a third temperature of the fluid inside the tube inlet port;
receiving fourth temperature data from a fourth wireless transmitter coupled to a fourth temperature sensor affixed to an outer surface of a tube outlet port of the shell and tube heat exchanger, the fourth temperature data indicating a fourth temperature of the fluid inside the tube outlet port;
receiving first flow rate data from a fifth wireless transmitter coupled to a first flow rate sensor affixed to the outer surface of the shell inlet port of the shell and tube heat exchanger, the first flow rate data indicating a first flow rate of the fluid inside the shell inlet port;
receiving second flow rate data from a sixth wireless transmitter coupled to a second flow rate sensor affixed to the outer surface of the shell outlet port of the shell and tube heat exchanger, the second flow rate data indicating a second flow rate of the fluid inside the shell outlet port;
receiving first pressure data from a ninth wireless transmitter coupled to a first pressure sensor positioned inside of a first Tee connected to the shell inlet port of the shell and tube heat exchanger, the first pressure data indicating a first pressure of the fluid inside the shell inlet port;
receiving second pressure data from a tenth wireless transmitter coupled to a second pressure sensor positioned inside of a second Tee connected to the shell outlet port of the shell and tube heat exchanger, the second pressure data indicating a second pressure of the fluid inside the shell outlet port;
receiving third pressure data from an eleventh wireless transmitter coupled to a third pressure sensor positioned inside of a third Tee connected to the tube inlet port of the shell and tube heat exchanger, the third pressure data indicating a third pressure of the fluid inside the tube inlet port;
receiving fourth pressure data from a twelfth wireless transmitter coupled to a fourth pressure sensor positioned inside of a fourth Tee connected to the tube outlet port of the shell and tube heat exchanger, the fourth pressure data indicating a fourth pressure of the fluid inside the tube outlet port; and
determining one or more fouling indicators based on the first temperature data, the second temperature data, the third temperature data, the fourth temperature data, the first flow rate data, the second flow rate data, the first pressure data, the second pressure data, the third pressure data, and the fourth pressure data, the fouling indicators indicating a likelihood of fouling occurring in the shell and tube heat exchanger.

11. The method of claim 10, further comprising:
receiving the first temperature data comprising a surface temperature of the outer surface of shell inlet port; and
determining the first temperature of the fluid inside the shell inlet port based at least in part on the surface temperature.

12. The method of claim 10, further comprising receiving the first temperature data from a signal repeater that re-transmits the first temperature data transmitted by the first wireless transmitter.

13. The method of claim 12, further comprising receiving the first temperature data from the signal repeater via a cellular connection.

14. A method comprising:
affixing a first temperature sensor to an outer surface of a shell inlet port of a shell and tube heat exchanger, the first temperature sensor configured to measure a first temperature of a fluid inside the shell inlet port;
affixing a second temperature sensor to an outer surface of a shell outlet port of the shell and tube heat exchanger, the second temperature sensor configured to measure a second temperature of the fluid inside the shell outlet port;
affixing a third temperature sensor to an outer surface of a tube inlet port of the shell and tube heat exchanger, the third temperature sensor configured to measure a third temperature of the fluid inside the tube inlet port;
affixing a fourth temperature sensor to an outer surface of a tube outlet port of the shell and tube heat exchanger, the fourth temperature sensor configured to measure a fourth temperature of the fluid inside the tube outlet port;
affixing a first flow rate sensor to the outer surface of the shell inlet port, the first flow rate sensor configured to measure a flow rate of the fluid inside the shell inlet port;
affixing a second flow rate sensor to the outer surface of the shell outlet port, the second flow rate sensor configured to measure a second flow rate of the fluid inside the shell outlet port;
positioning a first pressure sensor inside a first Tee connected to the shell inlet port, the first pressure sensor configured to measure a first pressure of the fluid inside the shell inlet port;
positioning a second pressure sensor inside a second Tee connected to the shell outlet port, the second pressure sensor configured to measure a second pressure of the fluid inside the shell outlet port;
positioning a third pressure sensor inside a third Tee connected to the tube inlet port, the third pressure sensor configured to measure a third pressure of the fluid inside the tube inlet port;
positioning a fourth pressure sensor inside a fourth Tee connected to the tube outlet port, the fourth pressure sensor configured to measure a fourth pressure of the fluid inside the tube outlet port; and
connecting a corresponding wireless transmitter to each of the first temperature sensor, the second temperature sensor, the third temperature sensor, the fourth temperature sensor, the first flow rate sensor, the second flow rate sensor, the first pressure sensor, the second pressure sensor, the third pressure sensor, and the fourth pressure sensor, wherein each wireless transmitter is configured to transmit data captured by a connected sensor to a computing device.

15. The method of claim 14, further comprising:
receiving first temperature data, the second temperature data, the third temperature data, the fourth temperature data, the first flow rate data, the second flow rate data, the first pressure data, the second pressure data, the third pressure data, and the fourth pressure data; and
determining one or more fouling indicators based on the received data, the fouling indicators indicating a likelihood of fouling occurring in the shell and tube heat exchanger.

16. The method of claim 14, further comprising:
receiving the first temperature data comprising a surface temperature of the outer surface of shell inlet port; and
determining the first temperature of the fluid inside the shell inlet port based at least in part on the surface temperature.

17. The method of claim 14, further comprising clamping the first temperature sensor onto the outer surface of the shell inlet port.

18. The method of claim 14, further comprising receiving the first temperature data from a signal repeater that re-transmits the first temperature data transmitted by a first wireless transmitter.

19. The method of claim 18, further comprising receiving the first temperature data from the signal repeater via a cellular connection.

20. The method of claim 14, wherein the first flow rate sensor comprises an ultrasonic sensor.
